(19) United States
(12) Patent Application Publication
(10) Pub. No.: US 2001/0006131 A1
(43) Pub. Date: Jul. 5, 2001

(54) Composite panel constructions

(76) Inventor: Charles Bream, Little Shelford (GB)

Correspondence Address: Alan I. Cantor, FOLEY & LARDNER, Washington Harbour, 3000 K Street, N.W., Suite 500, Washington, DC, 20007-5109, US

(21) Appl. No.: 09/738,891

(22) Filed: Dec. 18, 2000

Related U.S. Application Data
(60) Provisional application No. 60/174,595, filed on Jan. 5, 2000.

(30) Foreign Application Priority Data
Dec. 16, 1999 (GB) 9929734.3

(51) Int. Cl. H04R 7/00; G10K 13/00

(52) U.S. Cl. 181/167

(57) ABSTRACT

A composite panel (22) comprising a core (24) sandwiched between two faceskins (26), and a method of making the panel. Each faceskin (26) is reinforced with a low weight fibrous veil. The faceskins (26) are bonded to the core (24) using layers of adhesive (28). The composite panel is especially well-adapted for use in a panel-form bending wave loudspeaker.

This application claims the benefit of provisional application No. 60/174,595, filed Jan. 5, 2000.

### TECHNICAL FIELD

The invention relates to structural materials for composite panels and, more particularly, to structural materials used in the faceskins of sandwich panels, e.g. as used in panel-form bending wave loudspeakers. Such loudspeakers are, for example, described in WO97/09842.

### BACKGROUND ART

WO97/09842 and counterpart U.S. application Ser. No. 08/707,012, filed Sep. 3, 1996, disclose a type of resonant bending wave panel-form loudspeaker. The primary material requirements for a panel used in a resonant bending wave panel-form loudspeaker are low weight and high stiffness. This can be achieved using a sandwich panel construction with thin, high specific stiffness faceskins. Typically woven glass fibre and unidirectional carbon fibre reinforced plastics skins are used. These materials are traditionally used for structural applications, where high load levels are applied to thick sections. As a consequence, to minimise composite manufacturing times, these reinforcing materials are produced in relatively high weights (greater than about 100 gsm) and are not readily available in low weights.

### SUMMARY OF THE INVENTION

According to the invention there is provided a composite panel comprising a core sandwiched between two faceskins, wherein at least one faceskin is reinforced with a low weight fibrous mat. The fibrous mat has a weight of less than about 40 gsm. The fibrous mat may be continuous or have apertures. The fibrous mat may be in the form of a veil.

Fibrous veils/mats may be manufactured from a range of short or continuous fibres including, but not restricted to, glass, carbon, thermoplastic and natural fibres. These may be used alone or combined to produce a hybrid veil.

Traditionally, fibrous veils are used in a range of composite applications, including:

(a) surfacing layer on composite structures to prevent print-through of the coarser underlying structural reinforcement;

(b) as a conducting surfacing/filler to provide anti-static and electromagnetic shielding properties, and

(c) as a carrier in thermoset film adhesives, to increase handleability.

In all these applications the veil is used to enhance the aesthetic, electrical or handling properties of the host material and not for structural reinforcement. In the present invention, the fibrous veils/mats are used as the primary reinforcing agent for the faceskin.

The veils/mats may be converted into faceskins by embedding the veils/mats in a host matrix, such as a thermoplastic or thermoset resin. This may be carried out using a technique such as solvent impregnation, melt impregnation or lamination.

An added benefit of veil/mat reinforcements of a faceskin for a composite panel is that the fibre orientation can be controlled during veil manufacture. This may vary from random in-plane to highly aligned distributions, enabling the design and manufacture of faceskins to be optimised for specific panel aspect ratios. The fibres may be continuous or discontinuous; continuous fibres impart a higher strength reinforcement than discontinuous fibres.

The fibres may be overlapping. The veil/mat may be formed into a complex shape since the fibres are moveable relative to each other. In contrast, a standard stretch cloth contains continuous fibres that may not be formed into a complex shape.

The performance of a veil/mat reinforced composite faceskin is determined by the following factors:

(1) the properties of the reinforcing fibres and host matrix;

(2) the fibre length distribution in the veil/mat;

(3) the fibre orientation, and

(4) the fibre packing efficiency.

The effect of these factors on the composite stiffness may be determined by using the Krenchel modification of the Rule of Mixtures (see Equation 1).

E_{c}=η₀ η₁ E_{f} V_{f}+Eₘ (1−V_{f}) Equation 1

where E_{c}=composite modulus, E_{f}=Fibre modulus, V_{f}= Fibre volume fraction, Eₘ=Matrix modulus, η₀=orientation efficiency factor and ρ₁=length efficiency factor.

The reinforcement strength of the veil/mat may be increased by increasing the stiffness of the fibres.

According to another aspect of the invention, a method of manufacturing a composite panel comprises the steps of providing a core, providing two veil-reinforced faceskins, the veil having a low weight, and bonding the veil reinforced faceskins to the core. The method may further comprise embedding a low weight veil in a host matrix and curing the host matrix to form a veil reinforced faceskin.

In summary, the invention proposes the use of low weight fibrous veils/mats as the primary reinforcing constituent in a sandwich panel faceskin. The composite panel may be used as a loudspeaker diaphragm, for example in a bending wave loudspeaker. The loudspeaker may be a resonant bending wave loudspeaker as described in WO97/09842 and U.S. Ser. No. 08/707,012. The benefits in having this type of faceskin reinforcement for bending wave loudspeaker panels are as follows:

(1) fibrous veils/mats are available in low weights (i.e., less than about 40 gsm, and even as low as 8 gsm), which enable the production of thin faceskins with high specific stiffnesses, and this can lead to an increase in the sensitivity of the loudspeaker;

(2) the fibre orientation in the veils/mats can be controlled, enabling the panel properties to be optimised for specific aspect ratios;

(3) the use of hybrid veils enables a wide range of specific stiffnesses to be achieved, and

(4) veils/mats are of lower cost than unidirectional and woven reinforcements.

The composite panel may also be used in an automotive trim and bending wave loudspeaker diaphragm combination.

### BRIEF DESCRIPTION OF THE DRAWING

Examples that embody the best mode for carrying out the invention are described in detail below and are diagrammatically illustrated in the accompanying drawing, in which:

FIG. 1 is a perspective view of a resonant bending have composite panel embodying the present invention;

FIGS. 1a to 1d are exploded cut-away views of the fibres used in the skins of the composite panel of FIG. 1;

FIG. 2 is a graph comparing the effect of the addition of various types of veil to a polycarbonate composite faceskin according to the present invention; and

FIG. 3 is a graph showing the frequency response for two composite panels.

### DETAILED DESCRIPTION

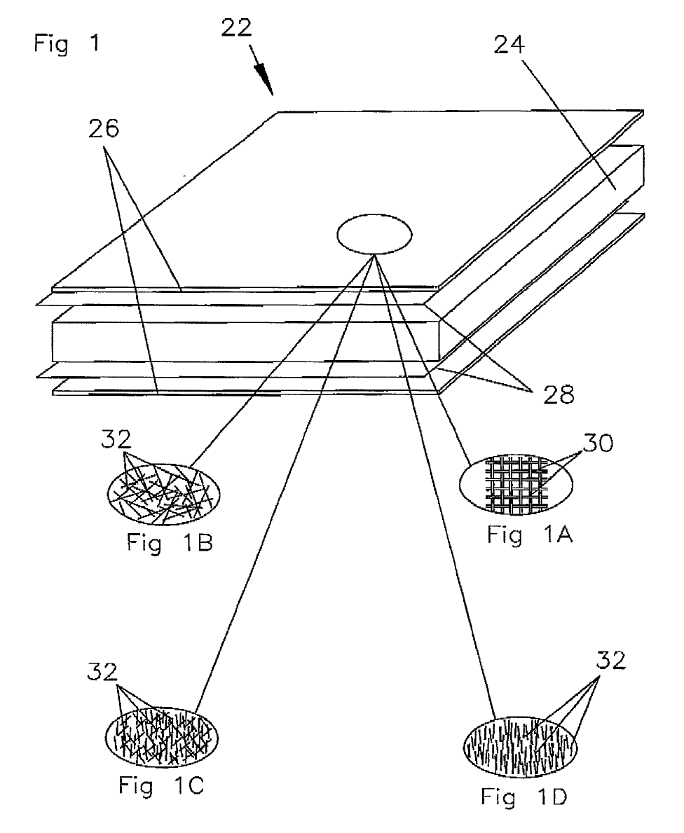

FIG. 1 shows a composite panel (22) comprising a core (24) sandwiched between two faceskins (26). Each faceskin (26) is reinforced with a low weight fibrous veil. The weight of the veil is less than about 40 gsm, and preferably no more than about 30 gsm. The faceskins (26) are bonded to the core (24) using layers of adhesive (28), e.g. thermoplastic resin or thermoset resin.

FIGS. 1a to 1d show the composition of the veil reinforcement of the faceskin (26). FIG. 1a shows the fibre composition of a veil formed from a woven cloth. There are continuous overlapping fibres (30) in a highly aligned arrangement and thus the cloth has high strength. FIG. 1b shows the fibre composition of a veil formed from short discontinuous fibres (32) in a highly random orientation. FIG. 1c shows the fibre composition of a veil formed from short discontinuous fibres (32) in a partially aligned orientation. FIG. 1d shows the fibre composition of a veil formed from short discontinuous fibres (32) in a highly aligned orientation.

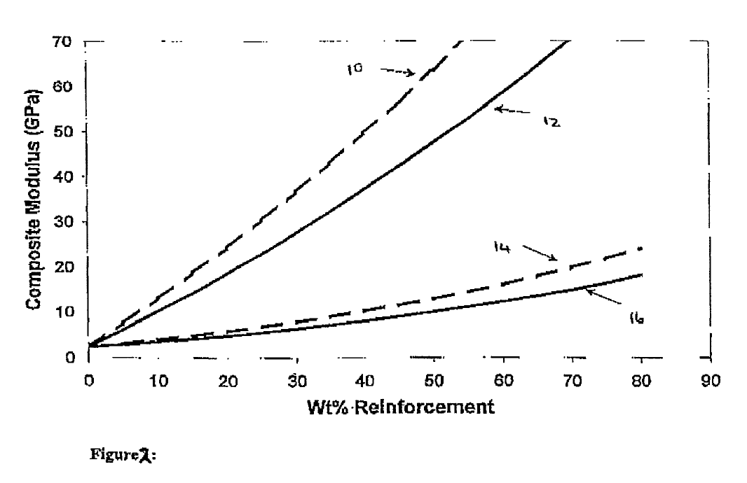

FIG. 2 shows a graph of composite modulus measured in GPa against the percentage weight reinforcement for two veils according to the invention and two comparison woven cloths known in the prior art which have been added to a polycarbonate composite faceskin. The graphs for the veils and the cloths are calculated using the Krenchel modification of the Rule of Mixtures (see Equation 1) For the veils, an in-plane random fibre distribution with a mean fibre length of 10 mm, an orientation efficiency factor η₀=⅜and a length efficiency factor η₁=0.99 has been taken.

The greatest increase in strength is achieved by using a 0°/90° carbon cloth as shown in line (10). Using a carbon veil according to the invention is marginally less effective as shown in line (12). A substantially reduced effect is obtained using 0°/90° glass cloth (14) and even less with a glass veil (16). FIG. 2 shows that at the same loading level, a veil achieves approximately 75% of the stiffness of a woven reinforcement made from the same material.

In practice the packing efficiency of veils (volume fraction ˜0.2) is lower than for highly aligned reinforcements (volume fraction of woven cloth ˜0.4). Taking this into account, Tables 1a and 1b compare the predicted performance of reinforced polycarbonate faceskins with typical materials used as panel-form bending wave loudspeaker faceskins. Table 1a shows the performance of a polycarbonate faceskin reinforced with a glass veil, a hybrid glass and carbon veil or a pure carbon veil.

As shown in Table 1b, the stiffness modulus of a normal polycarbonate skin is 2.3 GPa which is almost tripled to 6.4 GPa with a glass veil reinforcement and increased approximately ten-fold to 22.4 GPa with a carbon veil reinforcement. The carbon veil reinforced polycarbonate faceskin and the hybrid carbon-glass veil reinforced faceskin with at least 60% carbon in the veil are stiffer than the normal polycarbonate faceskins, dry Kraft paperboard faceskins and reinforced glass cloth polycarbonate faceskins. Only the polycarbonate faceskin reinforced with a woven carbon cloth betters the veil reinforced faceskins.

TABLE 1A
Predicted performance of veil reinforced polycarbonate faceskins

| | Fibre | Modulus | Density | Specific |
|---|---|---|---|---|
| | Loading | (E) | (p) | Stiffness |
| Reinforcement | Wt % | Gpa | g/cm³ | (E/p) |
| Glass Veil | 30 | 6.4 | 1.43 | 4.5 |
| 20% Glass-80% Carbon | 30 | 9.8 | 1.40 | 7.0 |
| Hybrid Veil | | | | |
| 40% Glass-60% Carbon | 30 | 13.1 | 1.38 | 9.5 |
| Hybrid Veil | | | | |
| 60% Glass-40% Carbon | 30 | 16.3 | 1.36 | 12.0 |
| Hybrid Veil | | | | |
| 80% Glass-20% Carbon | 30 | 19.4 | 1.34 | 14.5 |
| Hybrid Veil | | | | |
| Carbon Veil | 30 | 22.4 | 1.32 | 17.0 |

TABLE 1B
Predicted performance of other faceskin materials

| | Fibre | Modulus | Density | Specific |
|---|---|---|---|---|
| | Loading | (E) | (p) | Stiffness |
| Faceskin | Wt % | Gpa | g/cm³ | (E/p) |
| Polycarbonate | — | 2.3 | 1.20 | 1.9 |
| Dry Kraft Paperboard | — | 2.3 | 0.83 | 2.8 |
| 0°/90° Glass Cloth | 50 | 12.3 | 1.63 | 7.5 |
| Polycarbonate | | | | |
| 0°/90° Carbon Cloth | 50 | 50.6 | 1.41 | 35.9 |
| Polycarbonate | | | | |

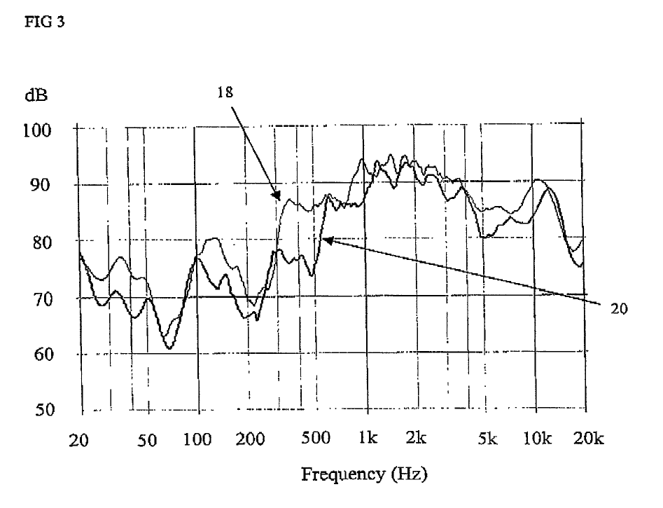

FIG. 3 shows the frequency response for two composite panels with output in decibels against frequency in Hertz. The first trace is a frequency response (18) for a composite panel made according to the present invention and comprising a Rohacell IG51 core with a thickness of 1.5 mm sandwiched between two skins. The skins are formed from a 20 gsm random glass veil with 50 gsm co-polyester thermoplastic matrix so that the matrix bonds the skins directly to the core. The second trace is a frequency response (20) for a prior art composite panel having the same core sandwiched between two standards skins. The skins are 0°/90° plain satin weave glass cloth with epoxy matrix, and have a thickness of 100 μm. The skins are bonded to the core using a 20 gsm copolyamide thermoplastic hot-melt film.

Typically 1.5 mm is the minimum thickness for a core. Adding a standard woven cloth reinforcing skin which is 10 μm thick leads to a panel which is overstiff for loudspeaker applications resulting in the poor frequency response (20). If the standard woven cloths of the prior art are replaced with 20 gsm random glass veils, FIG. 3 shows there is an increase in sensitivity and an increase in low frequency output for the frequency response (18). Accordingly, another advantage of the present invention is the improvement of low frequency output for a thin composite panel.

Incorporated herein by reference are UK priority application No. 9929734.3, filed Dec. 16, 1999, and U.S. provisional application No. 60/174,595, filed Jan. 5, 2000.

1. A composite panel comprising a core sandwiched between two faceskins, wherein at least one faceskin is reinforced with a low weight fibrous mat.

2. A composite panel according to claim 1, wherein the fibrous mat has a weight of less than about 40 gsm.

3. A composite panel according to claim 2, wherein the fibrous mat is in the form of a veil.

4. A composite panel according to claim 3, wherein the fibrous mat is manufactured from fibres selected from the group consisting of glass, carbon, thermoplastic and natural fibres, and mixtures thereof.

5. A composite panel according to claim 4, wherein the mat is formed from at least two types of fibre.

6. A composite panel according to claim 1, wherein the fibrous mat is in the form of a veil.

7. A composite panel according to claim 6, wherein the fibrous mat is manufactured from fibres selected from the group consisting of glass, carbon, thermoplastic and natural fibres, and mixtures thereof.

8. A composite panel according to claim 7, wherein the mat is formed from at least two types of fibre.

9. A composite panel according to claim 1, wherein at least one faceskin is formed by embedding the mat in a host matrix.

10. A composite panel according to claim 6, wherein the host matrix is a resin selected from the group consisting of thermoplastic resin and thermoset resin.

11. A composite panel according to claim 10, wherein the faceskin is formed using a technique selected from the group consisting of solvent impregnation, melt impregnation and lamination.

12. A composite panel according to claim 9, wherein the faceskin is formed using a technique selected from the group consisting of solvent impregnation, melt impregnation and lamination.

13. A composite panel according to claim 9, wherein fibres in the mat are oriented randomly in-plane.

14. A composite panel according to claim 9, wherein fibres in the mat are in a highly aligned distribution.

15. A composite panel according to claim 9, wherein the characteristics of the fibrous mat, namely fibre length distribution, fibre orientation and fibre packing efficiency are adjusted according to the Krenchel modification of the Rule of Mixtures to produce a reinforced faceskin having a desired stiffness.

16. A composite panel according to claim 1, wherein fibres in the mat are oriented randomly in-plane.

17. A composite panel according to claim 1, wherein fibres in the mat are in a highly aligned distribution.

18. A composite panel according to claim 1, wherein the characteristics of the fibrous mat, namely fibre length distribution, fibre orientation and fibre packing efficiency are adjusted according to the Krenchel modification of the Rule of Mixtures to produce a reinforced faceskin having a desired stiffness.

19. A loudspeaker diaphragm comprising a composite panel according to claim 18.

20. A loudspeaker diaphragm comprising a composite panel according to claim 9.

21. A bending wave loudspeaker diaphragm in the form of a composite panel comprising a core sandwiched between two faceskins, each of the faceskins comprising a fibrous veil having a weight of less than about 40 gsm embedded in a host matrix.

22. A bending wave loudspeaker diaphragm according to claim 21, wherein the fibrous veil is manufactured from fibres selected from the group consisting of glass, carbon, thermoplastic and natural fibres, and mixtures thereof.

23. A bending wave loudspeaker diaphragm according to claim 22, wherein the fibrous veil is formed from at least two types of fibre.

24. A bending wave loudspeaker diaphragm according to claim 22, wherein the host matrix is a resin selected from the group consisting of thermoplastic resin and thermoset resin.

25. A bending wave loudspeaker diaphragm according to claim 24, wherein the faceskin is formed using a technique selected from the group consisting of solvent impregnation, melt impregnation and lamination.

26. A bending wave loudspeaker diaphragm according to claim 24, wherein the characteristics of the fibrous veil, namely fibre length distribution, fibre orientation and fibre packing efficiency are adjusted according to the Krenchel modification of the Rule of Mixtures to produce a reinforced faceskin having a desired stiffness.

27. A bending wave loudspeaker diaphragm according to claim 21, wherein the characteristics of the fibrous veil, namely fibre length distribution, fibre orientation and fibre packing efficiency are adjusted according to the Krenchel modification of the Rule of Mixtures to produce a reinforced faceskin having a desired stiffness.

28. An automotive interior trim component adapted to operate as a loudspeaker according to claim 21.

29. A bending wave loudspeaker diaphragm in the form of a composite panel comprising a core sandwiched between two faceskins, each of the faceskins comprising a fibrous veil having a weight of no more than about 20 gsm embedded in a host matrix, wherein the characteristics of the fibrous veil, namely fibre length distribution, fibre orientation and fibre packing efficiency are adjusted according to the Krenchel modification of the Rule of Mixtures to produce a reinforced faceskin having a desired stiffness.

30. A bending wave loudspeaker diaphragm according to claim 29, wherein the fibrous veil is manufactured from fibres selected from the group consisting of glass, carbon, thermoplastic and natural fibres, and mixtures thereof.

31. A bending wave loudspeaker diaphragm according to claim 30, wherein the host matrix is a resin selected from the group consisting of thermoplastic resin and thermoset resin.

32. A method of manufacturing a bending wave loudspeaker diaphragm having a core sandwiched between two faceskins, comprising the steps of;
providing a core;
providing a fibrous veil having a weight of less than about 40 gsm;
embedding the veil in a host matrix; and
curing the host matrix to form a veil-reinforced faceskin bonded to each side of the core.

33. A method of manufacturing a bending wave loudspeaker diaphragm according to claim 32, wherein the fibrous veil is manufactured from fibres selected from the group consisting of glass, carbon, thermoplastic and natural fibres, and mixtures thereof.

34. A method of manufacturing a bending wave loudspeaker diaphragm according to claim 33, wherein the host matrix is a resin selected from the group consisting of thermoplastic resin and thermoset resin.
